(19) United States
(12) Patent Application Publication
(10) Pub. No.: US 2009/0101583 A1
(43) Pub. Date: Apr. 23, 2009

(54) HYBRID MEMBRANE MODULE, SYSTEM AND PROCESS FOR TREATMENT OF INDUSTRIAL WASTEWATER

(76) Inventor: Mordechai Perry, Petach Tikva (IL)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/293,297

(22) PCT Filed: Mar. 20, 2007
(86) PCT No.: PCT/IL2007/000363

§ 371 Date: Sep. 17, 2008

Related U.S. Application Data
(60) Provisional application No. 60/783,382, filed on Mar. 20, 2006.
(60) Provisional application No. 60/802,123, filed on May 22, 2006.

(51) Int. Cl. C02F 9/12; C02F 1/469; C02F 1/28; C02F 101/10; C02F 1/04; C02F 1/32

(52) U.S. Cl. 210/664; 210/206; 210/202; 210/681

(57) ABSTRACT

A process for reducing the content and volume of organic matter in a wastewater stream comprises contacting the latter with a nanofiltration device so as to obtain a concentrate, and a permeate as an aqueous stream containing any salts of non-precipitable metal ions which may be present, then contacting the concentrate with a preferably backflashable ultrafiltration device, and optionally also with activated carbon. This process may be part of a broader one which also removes other components from the wastewater stream. A module comprising (a) a nanofiltration device; (b) a preferably backflashable ultrafiltration device; (c) conduit(s) adapted to convey nanofiltration device concentrate to the ultrafiltration device; and optionally (d) a vessel containing activated carbon; as well as a system for treating a wastewater stream which includes this module, also form part of the invention.

### FIELD OF THE INVENTION

The present invention relates to a hybrid membrane module, system and process, for treating industrial wastewater and particularly for converting industrial wastewater containing organic materials and minerals into: (a) high quality water for reuse, (b) purified and highly concentrated salt brine for reuse or for easy disposal and (c) a highly concentrated aqueous stream of minimal volume, containing dispersed and dissolved organic substances for final destruction by oxidative means, such as wet air oxidation (WAO) or incineration.

### BACKGROUND OF THE INVENTION

All industrial plants in the chemical, petrochemical, pharmaceutical, metal and food sectors, for example, generate large quantities of wastewater streams containing, mixtures of suspended and dissolved substances which are difficult to separate. Typical aqueous wastewater stream from a pharmaceutical, agrochemical or fine chemical producing plant may contain high concentrations of organic matter (1000-10000 ppm TOC), of which 0.5%-30% is minerals. Varying concentrations of organic solvents, exemplified by solvents such as methanol, ethanol, IPA, ethyl acetate, toluene, xylene, DMF, NMP, THF, formamide and other organic solvents may be present in the wastewater stream. Some mineral and organic substances are present in the wastewater as saturated or supersaturated solutions and upon only a slight concentration of the wastewater stream by for example thermal distillation or membrane concentration process, they will separate as solid slurry that can precipitate on the surfaces and adversely affect any wastewater treatment equipment such as, publicly operated wastewater treatment plants (POWT), thermal evaporators, membrane plants, filters and even control equipment and piping. In addition to the above mentioned problematic constituents of the wastewater stream it often contains strong organic solvents that are particularly hazardous to membrane treatment plants such as reverse osmosis, electrodialysis or nanofiltration plants. Very often these organic solvents are present in saturated form and when concentrated in the membrane plant, they will separate in a form of small droplets or colloidal emulsions dispersed in aqueous stream. In effect every solvent droplet, such as those of toluene, xylene, methylene chloride, or chloroform is a 100% pure organic solvent. When contacting plastic surfaces of control equipment or membrane surfaces these droplets of aggressive organic solvents will attack the polymeric surface it contacts and will cause irreversible damage, shortening the life time of the membranes and of the equipment. It is therefore important to include in any wastewater system a proper pretreatment means that will remove such organic solvents prior to the main treatment step with, for example, membrane equipment. It must be pointed out that the pretreatment equipment membranes that are used for the pretreatment of the wastewater stream must be inter alia, solvent resistant.

Industrial wastewater streams from different chemical plants may contain hazardous compounds that adversely affect the environment and many biological wastewater treatment plants. As a result, their discharge into the POWT plants, into water transporting bodies and into the environment is strictly regulated by environmental laws. The list of such regulated compounds includes inter alia, AOX's (absorbable organic halogens), ammonia, heavy metals, phosphates and other organic and mineral materials that can inhibit the activity of naturally occurring bacteria and thus cause damage to the naturally occurring decomposition of organic matter and to the environment.

The discharge of minerals to the wastewater treatment plants is limited by law, so that in many cases the minerals must be removed and discharged according to regulations. Often the minerals can be recovered as valuable products, provided their purity is brought up to the standards of or according to certificates of such mineral products. Examples of such recoverable salts are: CaCl₂, CaSO₄, CaCO₃, Al₂(SO₄)₃ and others.

Because of the hazard that such wastewater can cause to the POWTs and to the environment, industrial firms are forced by law to treat their wastewater streams before discharging them to POWTs. The most accepted treatment is the biological wastewater treatment plant in which specially acclimated bio-organisms (bacteria) convert the organic matter into CO₂ with simultaneous formation of biomass. There are many types of biological wastewater treatment plants in operation worldwide. Some of them are operating in large settling basins where the separation of the biomass occurs as a result of natural settling, other concepts use bacteria immobilized to plastic surfaces, also well known is a combination of biological plant where bacteria are separated from the treated wastewater by means of ultrafiltration of microfiltration membranes; these are termed MBR's (Membrane Biological Reactors).

Many types of wastewater from industrial origin generate unique difficulties to the biological treatment plants. The major factors identified are:

(a) presence of non-biodegradable organic substances. These organic substances are difficult to decompose by microorganisms. Their conversion to CO₂ requires very long retention times and special conditions and in many cases these organic substances remain intact in the biologically treated wastewater streams, and constitute the main organic content (TOC-Total Organic Carbon) that is left in the treated wastewater. The TOC values caused by the non-degraded organic matter exceed by far the permissible discharge limits and are the main reason for high investments in post treatment facilities.
(b) presence of toxic organic molecules. These molecules can cause serious damage to the POWT and kill the biomass. Sometimes the only solution is to remove these molecules from the wastewater stream before the biological step.
(c) presence of high concentrations of minerals in the industrial wastewater cause the bio-mass to develop thick bacterial membrane, as protection means against high osmotic pressures, thus dramatically slowing down metabolic rates of conversion of these materials.

These factors are responsible for poor degradation of organic matter in industrial wastewater. Often the remaining concentration of the organic matter in the biologically treated wastewater can be as high as 1000-3000 milligram per liter while the required limits for discharge into the POWT are much lower: TOC<200 milligram per liter, AOX<1 ppm, ammonia less than 10 ppm.

For these reasons it is often necessary to improve the quality of the waste waster stream by installing a wastewater polishing unit either before the biological treatment plant (upstream processing) or after the biological wastewater treatment plant (downstream processing).

A general worldwide legislative trend is towards a so called Zero Liquid Discharge (ZLD) situation according to which all wastewater liquids will be treated and completely recycled at the factory level. The factory will be allowed to discharge from its premises only solid wastes. The purity of the remaining discharges and their amounts determine the overall cost of disposal; high purity solid minerals bear the lowest disposal price, while solid minerals with a high degree of organic contamination demand higher costs for their disposal. For these reasons the chemical industry is continuously evaluating and searching for the best technologies to treat industrial wastewater, aiming to meet the Zero Liquid Discharge (ZLD) requirements at minimal treatment costs. One of the aims of the Hybrid Membrane Technology (HMT) invention, disclosed here, is to provide the chemical industry with an advanced and cost effective wastewater treatment technology for reaching the ZLD targets.

Typical conventional treatment plants applied for treating industrial wastewater containing minerals, natural organic matter (NOM), low molecular weight humic substances, synthetic organic substances (SOC's) or taste and odor (T&O) are: oxidation, coagulation, sedimentation, sand filtration and adsorption on granular (GAC) or activated carbon (PAC).

The use of low pressure-driven membrane technologies such as microfiltration (MF) or ultrafiltration (UF) is also well known. However, these membrane tools are not efficient for removal of the low molecular weight contaminants.

A combination of UF and MF with powdered activated carbon (PAC) has been proposed in the literature and one of these publications is given here as a typical exemplifying reference [S. Mozia, M. Tomaszewska in Desalination 162 (2004)]. In the disclosed combination of activated powdered carbon and UF/MF, the membranes serve only as barriers, preventing the passage of carbon particles into the treated stream. The activated carbon is the factor that guarantees the quality of the treated permeate by absorbing the low MW organic matter. The UF recirculation loop serves as a reactor for mixing water and PAC and for the adsorption of the pollutants.

The effect of carbon particles on the stability of a membrane's flux is controversial, since some references mention that its presence helps to prevent fouling while according to others it has the opposite effect.

In order for the disclosed combination of PAC and UF/MF membranes to operate in an efficient way, the amount of the added activated carbon must be large, by far exceeding the amount of TOC in the wastewater. The reason is due to limited adsorption capacity of organic matter by the activated carbon; it is limited to 10-50% only, i.e. each gram of AC will adsorb only 0.1 gram to 0.5 grams of TOC. In the reference mentioned above, PAC dosage to wastewater amounted to 100 mg/liter, while the TOC concentration in the wastewater was less than 9 mg/liter. In this example, the ratio between PAC/TOC was higher than 11.

Another reference by H. H. P. Fang et al. in Desalination 189 (2006) teaches us that the amount of activated carbon that was added to activated sludge was 1670 mg/liter, the TOC concentration of which was 100-900 mg/liter, where activated carbon excess over TOC is in the range of 17 to 2.

The use of a large excess of activated carbon is costly and problematic particularly with a high TOC load e.g. of 1-3 gram/liter.

It will be shown in the disclosure of the present invention, that the amount of the activated carbon used in the hybrid systems of the present invention, are significantly lower than the values mentioned in the state of the art. Typically, 100 mg to 500 mg/liter only of activated carbon needs to be added to a wastewater stream containing 1000 mg TOC to 3000 mg TOC, in order to keep the ratio AC/TOC between the values of 0.03 to 0.16 only. Surprisingly, such low AC utilization was sufficient to ensure stable and high membrane fluxes in comparison with the fluxes measured in the absence of AC.

The use of wastewater treatment equipment combining a biological process with powdered activated carbon (PAC) is also known in the technical and commercial literature and some of these publications are given here as typical exemplifying references [PACT® http://zimpro.usfilter.com; Use of the PACT® System to treat Industrial Wastewaters for Direct Discharge or Reuse, John Meidl—USFilters, Zimpro Systems; The challenge of Treating a Complex Pharmaceutical Wastewater, Terrence Virnig, Joel Melka—Synthetech, Inc. and John Medl—USFilter Zimpro Systems].

These publications, however, do not suggest advantageously combining in a hybrid mode, activated carbon in powdered or granular form with ultrafiltration, nanofiltration or reverse osmosis membranes, in accordance with the present invention.

A combination of several membrane units such as ultrafiltration, activated carbon, electrodialysis and reverse osmosis are known in the state of the art. U.S. Pat. No. 4,676,908 (Ciepiela, et al.) shows a sequence of several consecutive steps such as aeration, dissolved air flotation, dual media, activated carbon adsorption, electrodialysis and ion exchange. The disclosed units differ from the present invention, since the units are serially arranged and each consecutive step operates as an independent unit; thus, there is no synergy in such an arrangement. The disclosed scheme is complicated, consumes large quantities of chemicals, and produces large quantities of residues, the disposal of which is very costly.

U.S. Pat. No. 6,425,974 (Bryant et al.) relates to the treatment of wastewater discharged from a bleach plant by means of ultrafiltration or/and nanofiltration, in order to recover a major fraction of organic substances without retaining minerals. Because of the high molecular weight of organic substances present, their concentration in the concentrate stream is significantly increased even when a relatively open membrane with MW cut off of 4000 Daltons is used, allowing most of the salts to pass into the permeate. This partly desalinated stream of concentrated organics serves for extracting additional organic substances from the bleach process, thus minimizing the volume of fresh water required for the process. In order to achieve optimal concentrate and permeate compositions, the volume concentration factors during the UF or NF step are kept at relatively low values of 2-7.5 only, i.e. volume reduction in the range of 50% to 15% only.

In the present invention, the objective is to separate organic substances, including those of low molecular weight, as much as possible without excessively retaining the minerals and to reduce the volume of these organic substances to preferably <5%, more preferably <1% and most preferably <0.1% of the initial wastewater volume. This objective is achieved by concentrating the organic molecules in the nanofiltration concentrate unit until they precipitate and then removing the precipitated organic matter from the NF concentrate by means of ultrafiltration. As a result, we are selectively concentrating the organic matter, allowing mainly minerals to pass into the NF permeate. While U.S. Pat. No. 6,425,974 mentions a possibility of combining ultrafiltration with nanofiltration, unlike the present invention, it does not instruct the reader as to either the structure or purpose of such combination.

U.S. Pat. No. 5,308,492 (Loew et al.) relates to the treatment of industrial wastewater, particularly referring to treatment of by-products from industrial processes such as dyeing or food processing, and from textile or paper industries. In these cases, the by-products are not easily degradable by biological processes and must be removed from wastewater before or after carrying out a conventional treatment, so that the wastewater can be discharged into surface waters or be reused without risk of pollution.

The Loew et al. patent discloses the use of a combination of nanofiltration, chemical oxidation and adsorption. The aim of the disclosed sequence of processes is to remove from the wastewater stream the non biodegradable molecules and separate a fraction with higher biodegradability so that the stream can be treated in a biological treatment plant. Carbon adsorption aims to remove from the stream certain non biodegradable molecules. This patent mentions ultrafiltration, but does not disclose any combination of ultrafiltration with nanofiltration. The present invention also differs from the disclosure in U.S. Pat. No. 5,308,492 in that the present invention requires only a relatively small fraction of activated carbon; and the cut-off of the NF membrane in the present case is such that a major fraction of the organic matter is retained in the concentrate, thus resulting in a treated permeate of much higher purity than the one that can be expected in the cited patent.

U.S. Pat. No. 4,981,594 (Jones et al.) relates to the treatment of cooling wastewater, particularly by a sequential combination of sand filtration for removal of large particles (50 microns), followed with disinfection by means of an ionization unit for removal of bacteria and algae, and a nanofiltration unit for the removal of small particles (5 microns). In contrast to this patent, the present invention aims to remove dissolved molecules having nanometer dimensions. This reference mentions a possibility of combining ultrafiltration with nanofiltration, but no details are described.

U.S. Pat. No. 6,007,712 (Tanaka et al.) discloses use of activated carbon as a carrier of immobilized microbes where the binding of microbes is done by means of a cross-linked hydrophilic polymer (acetylated PVA hydrogel). Such immobilized microbes become part of a biological wastewater treatment reactor. The suspended particles are retained by an ultrafiltration membrane with pores of around 13000 Daltons so that they cannot pass into the permeate. This reference, unlike the present invention, does not use nanofiltration, which functions to retain dissolved low MW organic substances, to concentrate them to the level at which they start to precipitate in the NF concentrate and then to use the UF membrane to remove the precipitating particles from the NF concentrate in order to keep it particle free. Also, in the present invention, the function of active carbon is to adsorb low MW organic matter that may foul the NF membrane, where the naturally adsorbed microbes help to decompose part of the adsorbed organic matter on the AC particles.

U.S. Pat. No. 4,956,093 (Pirbazari, et al.) discloses essentially a biological reactor comprising microbes adsorbed on activated carbon particles being stirred in a tank and used for decomposition of organic waste matter, suited particularly for decomposition of organic matter that is slowly or not at all biodegradable. The recirculation system includes an ultra filter to retain the suspended particles. This patent does not include nanofiltration.

U.S. Pat. No. 6,893,559 (Kin et al.) describes a system and method for removing organic compounds from wastewater by oxidation using UV/ozone.

The entire contents of the US patents and published US patent applications mentioned in the present specification are incorporated by reference herein.

### OBJECTS OF THE INVENTION

It is an object of the present invention to provide a module, system and process for treatment and recycling of hazardous industrial wastewater containing inter alia, dissolved and suspended organic matter, varying concentrations of minerals such as chlorides, bromides, bromates, chlorates, sulfates, phosphates, sodium, potassium, heavy metal ions, Ca, Mg and other ions, and organic solvents.

It is also an object of the present invention to provide a wastewater treatment process and system that is operating at maximum process recovery and capable of converting most of the wastewater into reusable materials. More typically, the originally hazardous aqueous wastewater stream will be generally converted to: (a) pure water (75-95%) with a quality that is suitable for reuse in the factory, (b) purified salt concentrate (5-10%) in a form of having mineral contents of at least 10%, usually 15% and preferably 20%; optionally, a further increase to 70% will be possible by incorporating a membrane distillation unit to treat the 20% brine, which is pure enough and adequate for final evaporation to a dry pure solid salt, by solar or thermal evaporation equipment, and (c) high organic concentrate in minimal volume, with minimal quantities of minerals suitable for final destruction by oxidation or incineration methods.

It is still a further object of the present invention to provide a process and system of the type described above in which several membrane and non membrane units are hybridized in one system, operating in an optimized, efficient and most economic way.

Yet another object of the present invention is to provide an optimized wastewater treatment and recycling process, where ultrafiltration, activated carbon column, nanofiltration, reverse osmosis, electrodialysis and catalytic oxidation sub-units are hybridized in a unique way that enables the achievement of high recoveries, highly purified recycled streams, fouling-free operation of all sub-units, minimal energy consumption and minimal costs.

### SUMMARY OF THE INVENTION

The present invention accordingly provides, in one aspect, a module, having utility in reducing the content and volume of organic matter in a wastewater stream containing the same, which comprises items (a), (b) and (c), and optionally (d): (a) a nanofiltration device; (b) a preferably backflashable ultrafiltration device; (c) conduit(s) adapted to convey nanofiltration device concentrate to said ultrafiltration device; and (d) a vessel containing activated carbon and conduit(s) adapted to convey nanofiltration device concentrate to the vessel for contact with the active carbon;

wherein the module comprises also: inflow conduit(s) adapted to convey the stream to the nanofiltration device; and outflow conduit(s) for the vessel, the ultrafiltration device concentrate and permeate and the nanofiltration device permeate.

The module of the invention is preferably further characterized by at least one of the following features: (i) the nanofiltration device has a cut-off of ≦1000 Daltons, preferably ≦500 Daltons and more preferably ≦160 Daltons; (ii) the nanofiltration device is stable at pH 7-14; (iii) the nanofiltration device is stable at pH 0-7; (iv) the nanofiltration device is stable in presence of water-miscible and water-immiscible organic solvents; (v) the wastewater stream is essentially free of salts of precipitable metal ions; (vi) the module also comprises a vessel containing activated carbon adapted for contact with inflow wastewater prior to contact with the nanofiltration device, provided that such activated carbon and any other activated carbon as recited in part (d) above, in whole or in part, may optionally support organic-matter-degrading bacteria. In a particular embodiment of the module which includes feature (vi), a single vessel containing activated carbon is operative to contact inflow wastewater, and to contact the nanofiltration device concentrate.

In another aspect, the invention provides a system for treating a wastewater stream containing salts of precipitable metal ions, salts of non-precipitable metal ions and organic matter including organic solvents and solutes, which comprises the following units:

(A) a reactor, provided with wastewater stream inflow conduit(s), inflow conduit(s) for reactants adapted to form water insoluble salts by reaction with precipitable metal ions in the stream, outflow conduit(s) for removal as a slurry of the water-insoluble salts, and outflow conduit(s) for conducting the stream depleted in precipitable inorganic salts to unit (B);
(B) an ultrafiltration device, adapted to reduce the content of salts of precipitable metal ions in the salts-depleted stream to less than 100 ppm, provided with inflow conduit(s) for the salts-depleted stream, inorganic salt precipitate ultrafiltration device concentrate outflow conduit(s) and essentially precipitable metal ion free ultrafiltration device permeate outflow conduit(s); and
(C) the module as defined hereinabove.

The system preferably includes additionally one of the following features (D1) (D2) and (D3):

(D1) a combination of electrodialysis and reverse osmosis membranes adapted to operate in series or in parallel, simultaneously or sequentially and to receive said nanofiltration device permeate having a reduced content of organic matter, in order to separate it into a concentrate containing essentially all of the salts of non-precipitable metal ions and a still more reduced content of organic matter, and a permeate of essentially pure water;
(D2) a membrane distillation unit operative to receive the nanofiltration device permeate, in order to separate it into a concentrate containing essentially all of the salts of non-precipitable metal ions and organic solutes and a permeate of essentially pure water; and
(D3) a combination of electrodialysis and membrane distillation membranes adapted to operate in series or in parallel, simultaneously or sequentially and to receive the nanofiltration device permeate in order to separate it into a membrane distillation condensate of essentially pure water and a mineral concentrate of the electrodialysis membrane(s) essentially free from organic contaminants.

More preferably, the system additionally includes at least one of the following features (E) and (F):

(E) a unit adapted for the destruction of organic matter received from the outflow conduit(s) of the ultrafiltration device concentrate, and optionally also from the vessel containing activated carbon; and
(F) at least one unit adapted to oxidize under ultraviolet radiation, any low molecular organic compounds at one or more of the following points:
(i) on the nanofiltration device permeate; and/or
(ii) on the reverse osmosis permeate and/or the electrodialysis concentrate (salt); and/or
(iii) on the membrane distillation permeate and/or on the membrane distillation concentrate.

In another aspect, the invention provides a process for reducing the content and volume of organic matter in a wastewater stream containing the same, which comprises contacting the wastewater stream with a nanofiltration device so as to obtain a concentrate, and a permeate as an aqueous stream containing any salts of non-precipitable metal ions which may be present in the wastewater stream, then contacting the concentrate with a preferably backflashable ultrafiltration device, and optionally also with activated carbon, in order to reduce the content and volume of organic matter in the concentrate.

In a further aspect, the invention provides a process for treating wastewater containing salts of precipitable metal ions, salts of non-precipitable metal ions and organic matter including organic solvents and solutes, which comprises the following sequential steps:

(A) contacting the wastewater with reactants adapted to precipitate water-insoluble salts of precipitable metal ions therefrom, removing the formed slurry of the water-insoluble salts, and conducting the wastewater depleted in inorganic salts to step (B);
(B) contacting the wastewater from step (A) with an ultrafiltration device adapted to reduce the content of precipitable metal ions in the salts-depleted stream to less than 100 ppm, and
(C) contacting permeate from the ultrafiltration device with a nanofiltration device so as to obtain a concentrate, and a permeate as an aqueous stream containing any salts of non-precipitable metal ions which may be present in the wastewater, then contacting the concentrate with a preferably backflashable ultrafiltration device, and optionally also with activated carbon, in order to reduce the content and volume of organic matter in the concentrate.

This process preferably additionally includes one of the following steps (D1) (D2) and (D3): (D1) contacting the nanofiltration device permeate with a combination of electrodialysis and reverse osmosis membranes adapted to operate in series or in parallel, simultaneously or sequentially, in order to separate the permeate having a reduced content of organic matter into a concentrate containing essentially all of the salts of non-precipitable metal ions and having a still more reduced content of organic matter, and a permeate of essentially pure water; (D2) contacting the nanofiltration device permeate with a membrane distillation unit, in order to separate the permeate into a concentrate containing essentially all of the salts of non-precipitable metal ions and a permeate of essentially pure water; and

(D3) contacting the nanofiltration device permeate with a combination of electrodialysis and membrane distillation membranes adapted to operate in series or in parallel, simultaneously or sequentially, and to receive the nanofiltration device permeate in order to separate it into a membrane distillation condensate of essentially pure water and a mineral concentrate of the electrodialysis membrane(s) essentially free from organic contaminants.

The process more preferably additionally includes at least one of the following steps:

(E) destroying the organic matter in the ultrafiltration device concentrate, and optionally also from the liquid outflow after contact with activated carbon; and
(F) contacting with ultraviolet radiation the nanofiltration device permeate, and/or the reverse osmosis permeate, and/or the electrodialysis concentrate (salt), and/or the molecular distillation permeate and/or the membrane distillation concentrate, in order to oxidize any low molecular organic compounds present therein.

In yet another aspect, the invention provides, in a process for reducing the content and volume of organic matter in a wastewater stream containing the same, the stream being essentially free of salts of precipitable metal ions, by contacting the wastewater stream with a nanofiltration device so as to obtain a concentrate, and a permeate as an aqueous stream containing any salts of non-precipitable metal ions which may be present in the wastewater stream; the improvement which comprises a step of prolonging the life of the nanofiltration device by contacting the concentrate with an ultrafiltration device, thereby continuously removing precipitated matter formed in the nanofiltration device.

### BRIEF DESCRIPTION OF THE DRAWINGS

In the figures, which illustrate, by way of example only, embodiments of the present invention:

FIG. 1 illustrates a schematic presentation of a wastewater treatment nanofiltration/ultrafiltration module operating through a common feed tank, with an optional activated carbon column, optionally including also a liquid/solids separation feature.

FIG. 2 schematically illustrates another embodiment of the wastewater treatment nanofiltration/ultrafiltration module, including a liquid solids separation feature and an organic solids destruction unit.

FIG. 3 schematically illustrates another embodiment of the nanofiltration/ultrafiltration module with individual feed tanks serving separately the UF and the NF subunits.

FIG. 4 schematically illustrates a pretreatment unit demonstrating removal of precipitable salts from the wastewater stream.

FIG. 5 schematically illustrates combining RO and ED membranes to separate the pretreated wastewater stream into: pure water, pure salt and a partially desalted organic stream for recycling back to the nanofiltration/ultrafiltration module or any pre- or post-subprocessing unit.

FIG. 6 schematically illustrates another embodiment of an ED-RO scheme demonstrating polishing of a feed stream and/or of a separated pure water stream, and/or a stream of concentrated minerals and/or a stream containing organics for destruction of organic residues by oxidation, which may be optionally UV oxidation, with or without chemical aids.

FIG. 7 schematically illustrates a membrane distillation unit, which separates the pretreated stream into pure water distillate and a contaminated stream of concentrated organic and mineral substances, where this contaminated stream is further purified in a hybrid ED unit separating the contaminated saline organic concentrate into an essentially organic free salt concentrate and a desalinated organic stream.

FIG. 8 schematically illustrates another embodiment combining a membrane distillation unit with ED working from a common feed tank, forming a pure water distillate, essentially pure mineral concentrate and an essentially desalinated stream of organic substances that are recycled back to the start of the process or to destruction of the organic substances. It also shows an option of further concentration of pure ED salt concentrate with a second MD step followed with a crystallization of salt to pure crystalline product.

FIG. 9 is a graph showing flux of NF membrane vs. amount of activated carbon added to the NF cell.

FIG. 10 is a graph showing concentration of organic matter (TOC) in feed, permeate and NF concentrate as a function of the concentration factor (VCF).

FIG. 11 is a graph showing the comparative flux behavior of a nanofiltration unit with and without hybridization with ultrafiltration on the nanofiltration concentrate.

### DETAILED DESCRIPTION OF THE INVENTION

In a particular embodiment of the present invention there are provided three sequential subunits as follows:

### 1. Pretreatment Unit/Step 1

This hybrid sub-unit combines a chemical reactor in which Ca, Mg, Ba, Sr, heavy metals, other precipitating metal ions, and ammonia are removed by the proper choice of e.g. pH and chemicals such as phosphates, carbonates, NaOH, and/or phosphoric acid, with an ultrafiltration/microfiltration unit equipped with preferably tubular, solvent stable membranes, that operate in a carefully selected concentration range of mineral precipitates and a slurry separating device comprising a settling tank or centrifugal separation equipment. In this hybrid step we achieve:
a. Complete removal of mineral and organic precipitates and colloidal particles.
b. Substantial removal of ammonia.
c. Maintaining membrane flux at very high and stable values due to the scouring effects of crystalline suspended matter and high circulation velocities.
d. Producing highly concentrated solid residues in the concentration range of between 7-50%.
e. Achieving very high product recoveries exceeding 99.5%.

### 2. Pretreatment Unit/Step 2

This hybrid sub-unit combines a nanofiltration unit, preferably equipped with solvent resistant membranes, an activated carbon column, which optionally serves as a feed tank to the NF unit, a second NF unit optionally equipped with solvent stable NF membranes in tubular or plate format as solvent resistant modules capable of operating in presence of slurry, and an UF unit for continuous removal of organic precipitates that are formed in the NF concentrate streams during the concentration step. In this hybrid pretreatment step we achieve:
a. Complete removal of aggressive organic solvents.
b. Maintaining high NF membrane flux as a result of continuous, selective adsorption of organic foulants from the wastewater stream that will, in the absence of the AC, accumulate at the NF membrane surface, foul the membranes and cause a severe flux decline to impractical levels. The combination of NF with AC continuously brings up the concentration of the depleting organic foulants and ensures that the AC step operates at high efficiency.
c. Continuously removing the precipitating organic particles and concentrating them as highly concentrated slurry for subsequent disposal or incineration.
d. Recovering more than 95% of the stream entering pretreatment unit 2 for final processing by the next treatment step.

Another preferred embodiment of pretreatment unit/step 2 includes in addition to the nanofiltration unit, and an activated carbon column, a biomass seeded in the concentrate tank of the NF system. The biomass can be incorporated in the form of dispersed bacteria particles or flocks or alternatively it can be immobilized onto the activated carbon particles or onto another carrier surface. Surprisingly, using such embodiment, it was found, that the concentration of the organic matter does not increase in the NF concentrate during the concentration process, but remains fairly constant and at a low concentration, as a result of continuous biological degradation of the concentrating organic material. More than 90% of the dissolved organic matter was degraded in such a hybrid unit. The decomposition of the organic matter in this embodiment by the bacteria proceeds in a very efficient way because the concentration of dissolved organic matter is constantly increased by the NF step, while being absorbed onto the carbon particles and/or subsequently bio-degraded by bacteria.

### 3. Separation Unit/Step 3

This hybrid unit utilizes Reverse Osmosis (RO), coupled with electrodialysis (ED), where the salt concentration is kept at a constant level in the range of 2-5%. This guarantees high RO fluxes, foulants free RO concentrate, high quality of RO permeate (low TOC and low salinity) and guarantees high salt concentration in the ED concentrate up to 25%. Optionally, the salt concentrate can be further concentrated by up to 70% by adding a membrane distillation unit and even to a solid salt by adding a membrane crystallizer coupled to a membrane distillation unit.

It is also possible to add an oxidation polishing step to remove residues of organic molecules from the RO permeate and or salt concentrate.

Otherwise expressed in a particular embodiment, the hybrid membrane (HMT) system of the invention, for treating a contaminated inflow containing organic matter and minerals, comprises (i) a unit for the removal of organic matter from the contaminated stream and concentrating the organic contaminants in a minimal volume of organic matter concentrate, (ii) a unit for recovering from the contaminated wastewater stream pure water product and (iii) a unit for recovering from the wastewater stream mineral concentrate or mineral slurry essentially free from organic contaminants.

The contaminated stream may contain organic substances in the concentration range of 0.1% to 0.5% or higher and mineral contents of 1% to 5% or higher. In addition, the stream may contain varying concentrations of organic solvents and of tens to thousands ppm levels of multivalent metal salts such as Ca, Mg, Ba, Sr, Al, Zn, Cr and others.

The HMT system may include several consecutive units including:

(i) an ultrafiltration unit for removing from the wastewater stream precipitating salts, thus forming a first pretreated stream containing essentially non precipitating salts and organic matter, such module comprising a mixing reactor with conduits and accessories for adding precipitating chemicals and control means to control the precipitation process; and an ultrafiltration membrane that serves for the removal of precipitating salts and any other precipitates in the form of suspended matter and colloids from the first treated stream.
(ii) a nanofiltration/ultrafiltration module for the removal and concentration of organic matter from the contaminated wastewater stream, that can be optionally a first pretreated stream, essentially free of precipitating ions first pretreated, but it can be also an original wastewater stream containing the precipitating salts. Such unit comprises:
(1) A nanofiltration membrane, which concentrates the low molecular weight organic matter and those precipitable minerals that were not removed from the first treated stream. The organic and mineral contents are concentrated and are precipitated in the nanofiltration concentrate and are continuously removed therefrom by directing part or the whole of such concentrate to an ultrafiltration device, see item (2) below. As a result of such hybrid arrangement, wherein simultaneous action precipitable matter is constantly concentrated, precipitated in the nanofiltration concentrate and constantly removed from the nanofiltration concentrate, the precipitated solids do not foul the nanofiltration membrane and plugging of the nanofiltration unit is eliminated. Without such combined action, fouling and plugging will occur in a very short time eliminating any possibility to continue the process.
(2) An ultrafiltration membrane device, that removes precipitates from the nanofiltration concentrate and replaces the stream being treated with ultrafiltration permeate that is free from any suspended matter. Thus, the process of concentrating, precipitating and removing the precipitates from the nanofiltration concentrate can continue indefinitely. The ultrafiltration unit is periodically backflushed, thus releasing the accumulated solid matter from the surfaces of the ultrafiltration membrane and from the channels of the ultrafiltration unit. The precipitates removed from the nanofiltration concentrate and accumulated in the ultrafiltration concentrate are separated directly from the ultrafiltration concentrate or optionally from a backflushed stream by means of a conventional settler clarifier device. The volume of the separated solids can be further reduced by means of various solids densification tools such as a filter press or a centrifugal decanter, while the filtrate or supernatant liquids with a low concentration of suspended solids are returned to the ultrafiltration membrane for an additional separation. As a result of such action the concentration of the organic phase can be increased many fold from for example 0.1% organic matter in the original contaminated wastewater to 5%, 10% or 20% or more in the concentrated slurry, namely progressively reducing the total volume containing such organic phase from 99.9 volume units in the original wastewater stream to 1.9, 0.9 and finally 0.4 volume units thus reducing the water volume by a factor of 250 fold or more. An additional drying step such as exemplified e.g. by a fluidized bed dryer, can reduce its volume to 0.1%, thus significantly reducing the costs of final oxidation, or destruction such as with plasma or incineration treatment means.
(3) An optional activated carbon column can be integrated into the nanofiltration stream, serving for the elimination of fouling of the nanofiltration membranes by certain soluble fouling organic fractions. The activated carbon (AC) column is added to the NF initial or recirculated input so that the contaminated liquid circulates across the NF membrane and the activated carbon column. Surprisingly, it was found that in such a unique combination of NF and AC, the flux of the NF membrane can be maintained at very high level, even if the amount of the AC is very low and constitutes only 100-250 mg/liter per processed contaminating liquid, while the concentration of the fouling organic matter in the contaminated liquid may be 10 to 20 fold higher than the concentration of the AC carbon in the contaminating liquid. In contrast, when such AC carbon column is removed, a severe fouling of the NF membranes is observed leading to a flux decline to unacceptable levels. The unique combination of the NF with AC, helps to keep the operation of the AC column at very high efficiency and capacity.

Another embodiment of the present invention includes an option in which such activated carbon is a carrier for organic-matter-degrading bacteria and can facilitate decomposition of the organic matter further helping to remove the organic matter from the NF membrane surface and further eliminating the fouling of the NF membrane. The biomass can be incorporated in the form of dispersed bacteria particles, or flocks, or alternatively it can be immobilized onto the activated carbon particles or onto another carrier surface. It was surprisingly found, using such an embodiment, that the concentration of the organic matter does not increase in the NF concentrate during the concentration process, but remains at fairly constant, low concentration values as a result of continuous biological degradation of the concentrating organic material. More than 90% of the dissolved organic matter was degraded in such a hybrid unit. The decomposition of the organic matter in this embodiment by the bacteria proceeds in a very efficient way because the concentration of dissolved organic matter is constantly increased by the NF step, while being absorbed onto the carbon particles and/or subsequently bio-degraded by the bacteria.

Bacteria used for seeding the active carbon can be any mixture of strains as used in commercial bio-reactors, e.g. as disclosed in U.S. Pat. No. 4,207,179 (McCarthy et al.) entitled “Bio treatment using carbon treated recycle and/or clarifier effluent backwash”.

In a particular embodiment, there may be utilized a unit/step for separating pure water, pure mineral concentrate and a still contaminated aqueous stream containing organic substances. The aim of this step is to generate essentially pure streams of water free of organic contaminants or an essentially organic free stream of minerals. The demineralized, salt-free stream containing organic substances can be recycled back to the beginning of the process for further separation or be sent to a biological treatment plant that will, in the absence of high salt content, effectively degrade the organic substances by means of bacteria. Another possibility is to pretreat the organic desalted stream with oxidizing means and send such partially degraded stream to a biological plant or to a separating unit. Several options for this purpose are possible:

(1) Use of Reverse Osmosis (RO) with Electrodialysis (ED), where the pretreated stream with reduced organic content is concentrated with Reverse Osmosis to the highest possible concentration where organic content is limited to such values that do not adversely affect the purity of the RO permeate and of the subsequent ED concentrate. In a subsequent ED step, an essentially organic free pure salt concentrate is removed, while desalinating the remaining organic stream so that it can be sent back to the biological degradation step.
(2) Use of RO and ED in a combined mode where the two streams are recycled between the two membrane units.
(3) Use of ED and RO via a common reservoir as disclosed in published PCT Patent Application No. WO 2006/074259 (see also published US Patent Application No. 20060144787, Schmidt et al.)
(4) Utilizing instead of RO, a membrane distillation (MD) unit, which produces a high purity distillate and a concentrate that can be further purified with ED, intended to increase the purity of the mineral concentrate by reducing its organic contents.

Other aspects and features of the present invention will become apparent to persons of the art, upon review of the following description of specific embodiments of the invention in conjunction with the accompanying figures.

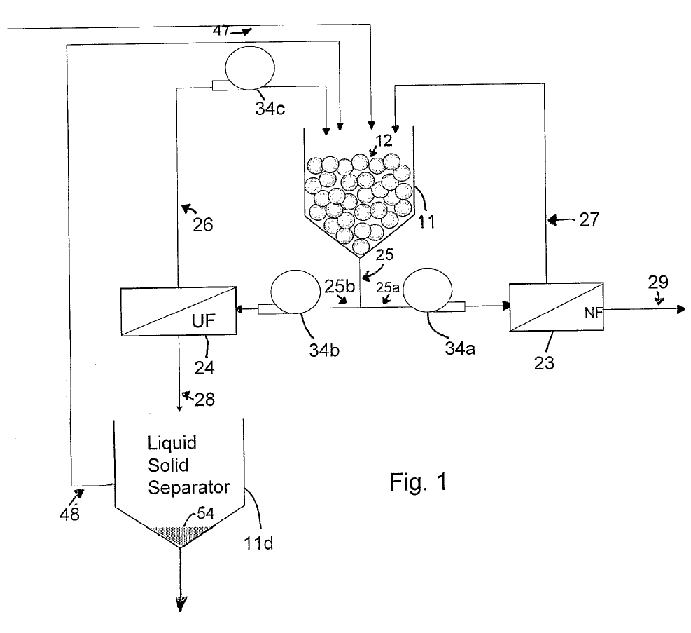

FIGS. 1-8 illustrate embodiments of the module, hybrid membrane system (HMT) and manner of operating the process of the invention, which e.g. may be applied to treat contaminated industrial liquids and wastewater emerging from a variety of industrial plants such as: pharmaceutical plants, plants manufacturing agro-chemicals, fungicides, or biocides, yeast production plants, alcohol fermentation plants, plants manufacturing additives to the polymer and chemical industries and also leachates from municipal dumping sites, sugar manufacturing plants, pulp and paper factories, metal processing plants and electronic plants. The composition of these complex wastewater streams vary from one plant to another, but they all have a common compositional structure where minerals, organic solutes, and organic solvents in dissolved, precipitated and precipitable forms, a complex treatment problem. Some of the organic compounds are hazardous by nature and must be destroyed using very expensive destruction means such as wet air oxidation, incineration, plasma decomposition and the like. In order to minimize the volume of the stream containing the hazardous organics, evaporation of the wastewater is very often used, which by itself is expensive, energy intensive treatment technology, that suffers from many operational and maintenance problems.

The HMT's module, system and process of the present invention aim to reduce the complexity of the problem by separating the complex mixture into less complex streams, thereby recovering from such streams as much as possible easy to dispose and preferably reusable materials. The separate purified fractions are: pure water, pure mineral concentrate that is essentially free from organic contamination and organic stream contained in as small as possible a volume with the highest achievable concentration of organic compounds. Such separation offers several important advantages:

(1) Water of sufficiently high quality can be reused in the factory as a feed to cooling towers or as process water, thereby minimizing the volume of the hazardous stream;
(2) Purified mineral concentrate can be discharged into the sea or evaporated in evaporation ponds or recovered as valuable mineral concentrate for reuse;
(3) Reducing the treatment costs of the organic residue, that is essentially free from mineral contaminants. A dramatic reduction of costs is achieved which is proportional to the volume reduction factor. Furthermore, in many cases, the purified organic concentrate is of great economic value and may generate revenues in contrast to the conventional approach using thermal methods or incineration where the organic matter is mixed with minerals and cannot be reused.

Thus, the costs of treatment of industrial wastewater using the present HMT invention will be only a fraction of the costs of treatment required with conventional approaches, where all the volume of wastewater must be treated or evaporated prior to final destruction.

Membrane technologies are categorized as pressure-driven membrane units, such as UF, NF and RO; as concentration driven such as diffusion dialysis and membrane distillation (MD); and as electrically driven electrodialysis (ED) units. These units are well known in the art and mainly used in water desalination processes and in a limited number of industrial applications. The main drawbacks limiting these technologies from being accepted on a large scale in wastewater treatment and in industrial process applications are: (a) their sensitivity to fouling and plugging when subjected to a variety of organic and mineral foulants and (b) their limited chemical stability to a variety of substances and conditions often found in the industrial and other wastewater streams. In addition, sensitivity to extreme pH conditions, the presence of aggressive organic solvents, and to oxidants adversely affect the performance of membranes and shorten their life.

The current invention offers a possibility to overcome most of the above mentioned drawbacks allowing a widespread acceptance of membrane technology for treating industrial process and wastewater streams as described in detail below.

In the following description of the figures, similar elements in the Figures are generally numbered with similar numerals.

Referring now to FIG. 1, which depicts a wastewater treatment nanofiltration unit where stream via conduit 41 (not shown) or stream via conduit 47, from an optional first pretreatment step, is fed into a tank 11 (preferably containing activated carbon 12), circulated by means of a pump 34a via conduits 25 and 25a across a nanofiltration membrane 23 and the feed tank 11 and forces the resulting permeate to pass across the membrane. The NF permeate contains mainly minerals and only low concentrations of very small organic molecules. Preferably, the NF membrane used in this stage is chemically and solvent stable and will endure the presence of aggressive organic chemicals or solvents.

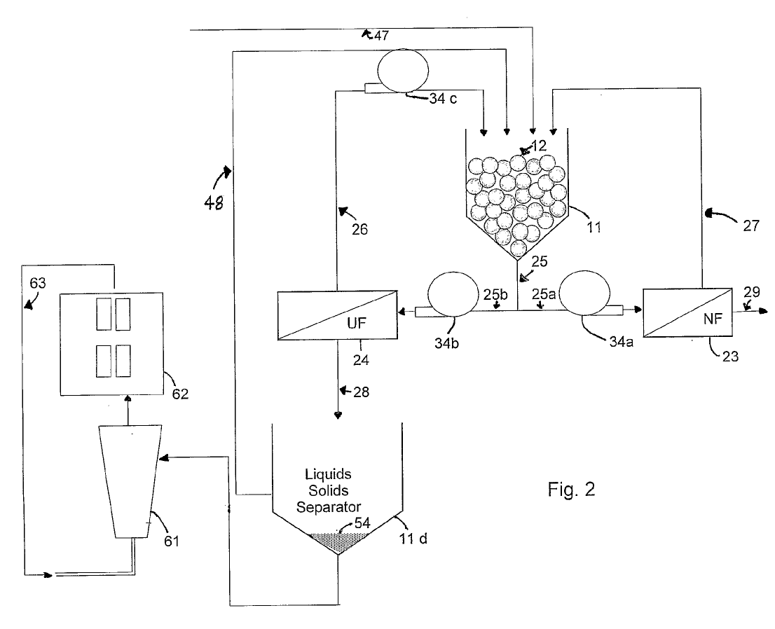

During the NF step and as a result of the passage of the permeate through tank 11 and membrane 23, the low MW organic compounds are concentrated and upon reaching their solubility limit they precipitate in the NF unit. In order to avoid accumulation of the fouling organic precipitates on the membranes, they are constantly removed from the NF concentrate by means of UF membrane 24 via tank 11, conduits 25 and 25b, and pump 34b. The particle free UF permeate is returned to the NF tank, helping to keeps the NF concentrate practically free of suspended foulants. Suspended matter 54 from a UF concentrate 28 is optionally separated in a liquid solid separator 11d. The supernatant fluid 48, lean in suspended matter, is returned to tank 11. Referring also to FIG. 2, as a result of the NF-UF hybridization, the NF unit operates at optimal, foulant free conditions, while the organic matter highly concentrated in minimal volume is removed for e.g., drying in a fluidized bed dryer, or thermal distillation unit 61, prior to final and economic destruction by one of the following destruction methods, namely, plasma decomposition, incineration or chemical thermal destruction unit 62, with optional recirculation via conduit 63. Again, optionally, the hot gases from these processes can be recycled to a fluidized bed drier. As said above, a dramatic volume reduction can be achieved with the hybridized NF-UF unit described above. Typically, the volume of the organic concentrate will be less than 5% of the volume of the stream via conduit 47 or via conduit 41 volume, preferably less than 1% of these streams' volume and most preferably less than 0.5%.

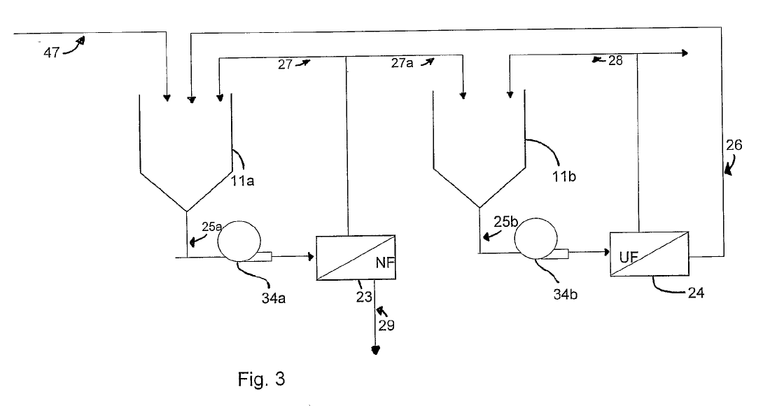

In another embodiment, the solids from the UF membrane are periodically back-flushed with the UF permeate using pump 34c. The back-flush stream of the UF membrane or the bleed stream of the UF concentrate are directed via conduit 26 to a tank 11a (FIG. 3) where the suspended solids from the UF concentrate stream are settled and separated, while the stream, lean in solids, is returned to tank 11, thereby allowing additional minimization of the volume of the organic solids to below 0.1%.

In another disclosed embodiment of the NF-UF module (FIG. 3) tanks 11b and 11a feeding the UF and the NF membranes, respectively, are equipped with conduits to pass the permeate from the UF membrane via conduit 26 to tank 11a and additionally, the concentrate of the NF module is directed via conduit 27a to tank 11b and thus via conduit 25b and 34a to the UF membrane.

In another embodiment of the present invention, the concentrate from the NF membrane is recycled back into a column containing activated carbon (AC) 12, preferably located in tank 11. The soluble organic foulants that are capable of fouling the nanofiltration membrane are continuously and selectively absorbed by the AC during the concentration process, thus avoiding fouling of the NF membrane. By hybridizing the two processes, namely the NF and AC in one integral unit, both sub-units are operating in an optimal way; the absorption efficiency of the AC dramatically increases because of the constant concentration increase of the organic foulant that otherwise would be depleted in the wastewater stream as a result of adsorption by the AC, and on the other hand, the flux of the NF membrane remains high due to the absence of fouling substances in the stream. As a result of this hybridization, the amount of the activated carbon consumed is very low; i.e., AC consumption of only 1-10% per each kg of TOC that is present in the wastewater stream in contrast to 50% or higher consumptions of activated carbon required in conventional activated carbon processes that operate without the NF membrane step. Surprisingly, the consumption of the activated carbon observed in actual waste treatment applications was as low as only 100 mg/liter of treated wastewater volume, which contained between 1000-5000 ppm dissolved organics (TOC). This is in contrast to any disclosures in the literature where the required amounts of the AC were almost an order of magnitude higher.

In such a non-fouling regime, very high recoveries, exceeding 98-99%, can be achieved during the nanofiltration step without encountering fouling problems.

In another embodiment of the present invention, the activated carbon may serve as a growth substrate for bacteria that can degrade organic matter. As a result of the hybridization of AC and biomass a much more effective degradation of the organic matter is achieved due to a high concentration of soluble organic matter in the NF concentrate.

Another feature of the present invention provides for the possibility of separating the pretreated stream from the nanofiltration membrane 23 via conduit 29 into (a) essentially pure water having zero or negligible concentrations of saconduit and organic contaminants and (b) pure salt essentially free from organic contaminants.

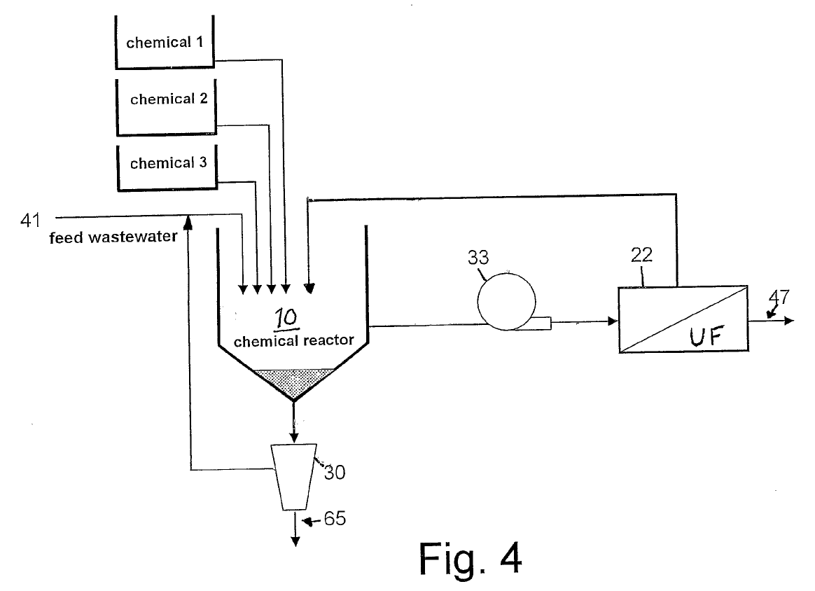

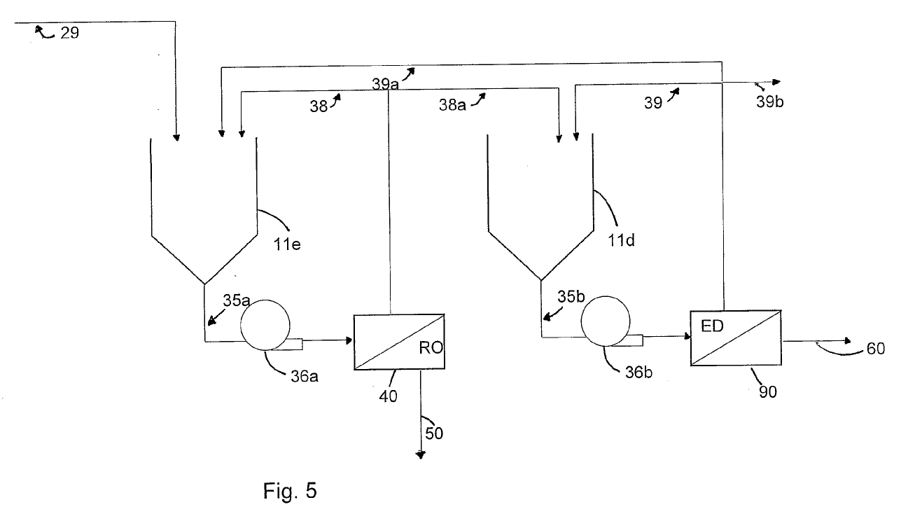

In one embodiment, disclosing a pretreatment unit as illustrated in FIG. 4, the wastewater containing a mixture of salts of precipitable metal ions, salts of non-precipitable metal ions and organic matter including organic solvents and solutes is fed via conduit 41 into an optional separation unit aiming to remove from it all precipitable minerals; such unit comprising a chemical reactor-separator-clarifier 10, a pump 33, an ultrafiltration membrane 22; and optionally a liquid-solid separator 30. Precipitation chemicals (e.g. chemical 1, 2, 3) are added to the chemical reactor 10, causing precipitable minerals to precipitate and separate in the bottom part of the reactor. The clarified stream, lean in precipitable contents, is fed into the ultrafiltration membrane 22 for separating and concentrating all suspended and colloidal matter that is recycled back to the separator-clarifier. The clear, precipitate-free ultrafiltration permeate is fed to a subsequent unit via conduit 47. The precipitates are transferred from the bottom of clarifier 10 and optionally condensed into a concentrated solid slurry 65, while recycling the filtrate or decantate back to the chemical reactor for an additional reprocessing. Another embodiment of the separating—concentrating system comprises use of RO membrane 40 and ED unit 90 as seen in FIG. 5. The feed is a pretreated stream issuing from conduit 29 after processing or recycling through the nanofiltration membrane and has no precipitable ions and a very low concentration of organic solutes. Only such a pretreated stream is suitable for processing in the RO-ED system. The low concentration of organic solutes in the RO concentrate tank 11e makes it possible to reach high water recoveries in the RO step without reaching excessive concentrations of these, well retained, organic solutes, thus minimizing their passage into the RO permeate. The process is optimized in such a way as not to allow the levels of the organic substances to exceed the permitted values, so that high quality RO permeate, with low or nil organic contents can be achieved, that can be reused as cooling water, process water or for any other use. If an NF-pretreated feed stream to the RO step is not used, the concentration of the organic solutes in the RO concentrate will be too high and a significant part of these organic solutes will pass into the permeate, making it unsuitable for reuse in the above mentioned applications.

Furthermore, as can be appreciated by a person skilled in the art, without performing the nanofiltration step prior to the RO step, many organic substances, including water immiscible organic solvents, that are retained by the RO membranes, can be concentrated above their solubility limit and may start precipitating in the RO concentrate tank 11e and may plug both the liquid channels of the RO elements and foul the membranes. In a similar way, the concentrated organic solvents may accumulate on the surfaces of the RO membranes as micro-droplets of pure solvents and may damage the RO membranes. Thus, the pretreatment step with the nanofiltration unit described above is essential in order to avoid such fouling and damaging effects of the RO membranes, and thus enabling very high recoveries in the RO step. High water recovery is an essential condition for any cost effective wastewater treatment process.

In addition to elimination of fouling that can be caused by the organic foulants and organic solvents, it is also important to realize that without the removal of the precipitable salts, that is achieved by using the chemical pretreatment step, followed with a nanofiltration step as described above, high recoveries at the RO step are not achievable, because of the precipitation of the mineral foulants on the RO membrane, again preventing achieving high water recoveries.

High water recoveries that can be achieved thanks to the previously mentioned pretreatment only, increase the concentrations of the water soluble minerals in the RO concentrate and generate high osmotic pressure that would prevent a further continuation of the RO concentration step and the achievement of the desired high water recoveries.

It is well known in the state of the art that aqueous foulant-free mineral concentrate can be easily desalted by means of electrodialysis unit 90. One possible option is to transfer the RO concentrate via conduit 38a to a separate tank 11d that feeds the ED unit via conduit 35b by means of pump 36b, recycling the stream from ED unit 90 via conduit 39 back to tank 11d in order to continue the desalination process to a desired level. The ED purified salt concentrate issuing from conduit 60, that can be achieved in this step, is essentially free from organic contaminants (including organic solvents), which were removed in the previous nanofiltration step. High concentrations of ED concentrate can be achieved in the ED step, thanks to the absence of the precipitable mineral ions that were removed in the above-mentioned chemical treatment steps. Without such chemical treatments the achievable salt concentrations in the ED concentrate are limited to 1-2% only, in order to avoid a precipitation of precipitable ions such as CaSO₄ or BaSO₄ in the ED concentrate. In order to reduce the transport of sulfate ions and to increase to some extent the concentration of minerals in the ED concentrate, selective monovalent-selective-anion-exchange membranes are often used that preferentially pass the monovalent Cl⁻, NO₃⁻ and HCO₃⁻ and minimize the transport of divalent SO₄⁼ ions. One of the major applications of ED using monovalent selective ED membranes is a formation of salt concentrates (˜20% w/w) from sea water. The present inventive process enables reaching high concentrations of ED concentrate avoiding the precipitation of the precipitable salts without the need to use monovalent selective electrodialysis membranes. However, the use of such monovalent selective membranes in the inventive process of the present invention is also possible and may extend the achievable salt concentration in the ED concentrate.

After desalting the ED feed stream from conduit 35b via pump 36b to a desired level it can be returned via conduit 39a to the RO feed tank 11e in order to continue concentration in the RO step. The combination of the ED with the RO step can be effected as two completely separated steps or as an integrated process where ED and RO are operating simultaneously while recycling part of the stream via conduit 39 from ED unit 90 to tank 11d and part of this stream will be circulated to tank 11e via conduit 39a. In a similar way, the stream issuing from the RO step via conduit 38 can be circulated to tank 11e (and reinserted via conduit 35a and pump 36a) and via conduit 38a to tank 11d (and reinserted via conduit 35b and pump 36b) in order to maintain certain liquid levels and concentration levels as required by the process. While application of such separate steps of ED and RO are not unique and are known in the state of the art, the combination of these steps with the previous nanofiltration step and chemical pretreatment steps, in order to avoid fouling and damaging the RO and ED membranes and in order to achieve high recoveries, without membrane fouling and with high purities of RO permeate and ED concentrate, are novel and achieve results not possible in the past.

The published patent applications of Schmidt et al., referred to above, disclose use of integrated electrodialysis with RO or NF systems for treatment of contaminated liquids. The focus of the disclosure is in increasing efficiency of desalination, namely the removal of minerals from the 90-96% in the conventional ED to above 98+% in this integrated process. Schmidt et al., however, do not disclose use of any pretreatment that would remove precipitable organic solutes, minerals and organic solvents. As a result, it would be clear to those skilled in the art that the combined process of Schmidt et al. will fail to work in presence of precipitable organic and mineral substances and that the presence of organic solvents will damage the RO and ED membranes.

Thus, the present invention where chemical treatment may be combined with UF and NF and optionally, with any type of ED/RO combination is unique and allows for achieving high water recoveries and high purity products (RO permeate and ED concentrate).

Many industrial and wastewater streams may contain water soluble low molecular weight organic substances that are not retained by most NF, RO and ED membranes. Typical examples are ethanol, methanol, tetrahydrofurane, acetone and others. As a result, known processes may not generate sufficiently pure treated water and mineral concentrates that can be recycled or reused. Most of these molecules are not adsorbed with sorbent materials such as active carbon or other adsorbents, thus, in order to reduce their concentration from the treated stream physical destruction of such molecules is required. Some of the possible means are chemical oxidation with ozone, or hydrogen peroxide with or without catalysts. Many such destruction means are known in the art. Some of the most advanced treatment schemes are those combining UV treatment technologies with or without the addition of chemicals and catalysts.

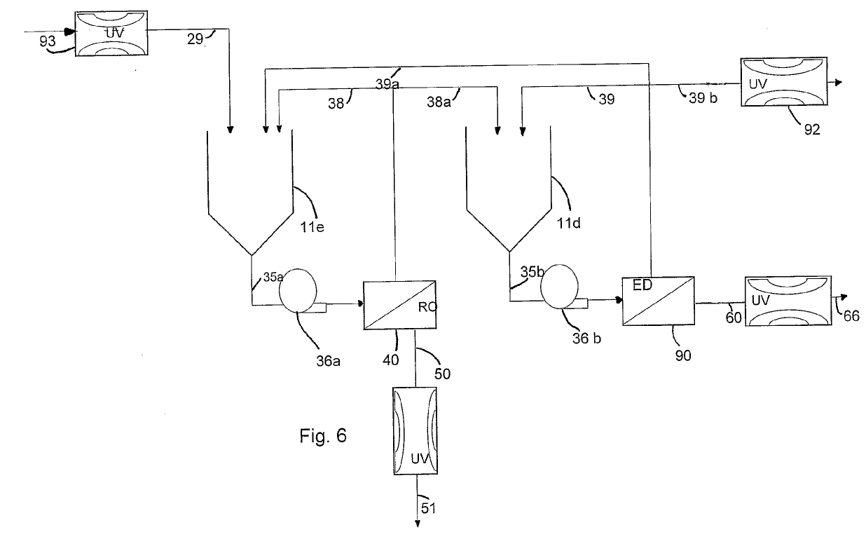

One preferred embodiment of the present invention includes a combination of the present system and process with any of the above mentioned organic destruction means. FIG. 6 illustrates post treatment of aqueous RO permeate issuing from conduit 50 and ED salt concentrate issuing from conduit 60 with e.g., UV destruction devices, from which polished streams issue via conduits 51 and 66, respectively. Such devices, 93, 92 can also be positioned, respectively, on pretreated stream input conduit 29 or on the residue stream, ED dilute via conduit 39b. Furthermore, such organic destruction means can be integrated at any location in the treatment system and process where it may improve the quality of the end products and stream residues.

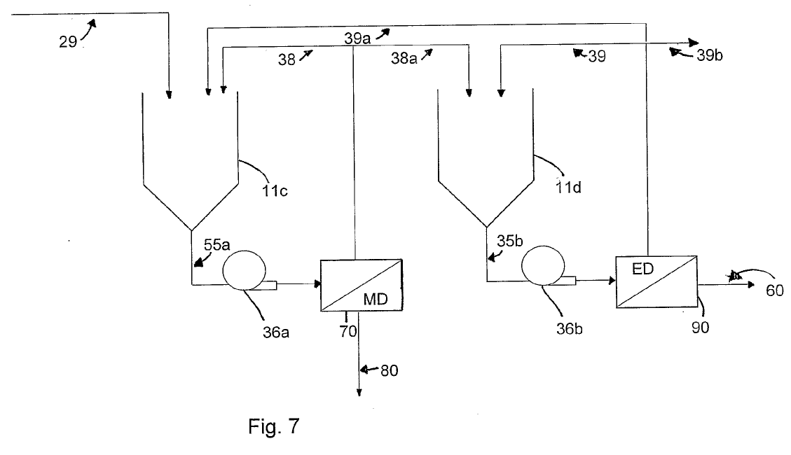

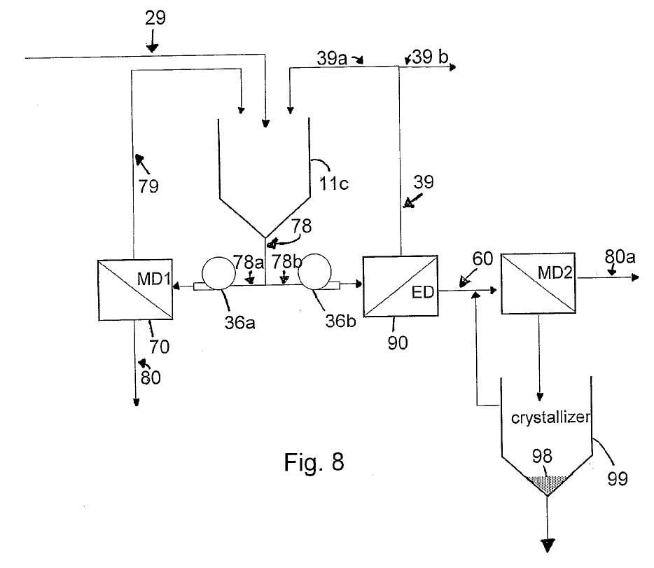

In one preferred embodiment of the invention, illustrated in FIGS. 7 and 8, the NF pretreated stream essentially free from precipitable salts and organic substances is fed into tank 11c and circulated to membrane distillation (MD) unit 70 by means of conduit 55a (or conduits 78, 78a) and pump 36a via conduits 78 and 78a and back via conduit 38 or 79 to tank 11c. The product of this subunit is essentially pure water issuing from conduit 80 that is free from any mineral and organic contaminants and having a quality that can be used as process water or as feed for cooling towers. The concentrate of the MD step loaded with both mineral and organic contaminants is simultaneously circulated via conduits 78 and 78b and by means of pump 36b to electrodialysis unit 90 that serves to separate minerals from non charged organic substances. A highly purified salt concentrate issuing from conduit 60 can have a concentration of 10% w/w, preferably 20% w/w and most preferably 25% w/w of purified minerals that can be discharged for final evaporation into evaporation ponds, or thermal evaporators-crystallizers for recovery of purified salt concentrate.

Alternatively, the purified salt concentrate issuing from conduit 60 can be subjected to another membrane distillation unit (MD2) combined with a crystallizer 99 thereby producing pure crystalconduit salt 98 and a mother liquor that can be recycled and recovered. The pure water stream from conduit 80a, from the second MD unit, can be combined with a pure water stream from conduit 80, from the first MD unit. As a result of such treatment, essentially pure water and essentially pure salt crystals are the main product from these embodiments.

One of the preferred embodiments of the present invention is a process involving the following steps:

(a) Subjecting the contaminated stream to a chemical pretreatment step which removes and filters out by micro or ultrafiltration all precipitated minerals and suspended matter,
(b) Treating a first stream with one of the above-described versions of an NF-UF module for the removal and concentration of organic substances,
(c) Subjecting the previously pretreated stream to a RO or MD step for production of treated water and
(d) Treating the concentrate stream from RO or MD step (c) with electrodialysis in order to produce essentially organic free mineral concentrate for easy discharge or reuse.

The process of the present invention may also optionally include any one of the following additional steps alone or in combination:

(e) Polishing, as necessary, the streams with a UV oxidation step,
(f) Destroying the organic concentrate from the NF and UF modules with plasma treatment, chemical destruction treatment or incineration and
(g) Using the heat generated from these thermal processes for concentration of the organic concentrate residues or mineral streams.

One of the preferred embodiments of the above process is the one producing permeate water quality containing less than 100 ppm dissolved matter, optionally less than 10 ppm dissolved matter and preferably less than 1 ppm of dissolved matter and giving a concentration of the organic matter in the treated water stream that is less than 100 ppm TOC, preferably less than 30 ppm TOC and most preferably less than 1 ppm TOC.

An additional embodiment of the above process is one in which the concentration of the mineral salts in the mineral salt concentrate or slurry constitutes more than 12% w/w, preferably more than 20% w/w, more preferably more than 40% and most preferably more than 70% w/w and the concentration of the organic matter in the mineral concentrate or slurry is lower than 1000 ppm TOC, preferably lower than 100 ppm TOC, more preferably lower than 50 ppm TOC and most preferably lower than 10 ppm TOC.

Another preferred embodiment of the present invention is the one in which the volume of organic concentrate after treatment is less than 15% of the original contaminated wastewater stream, preferably less than 5%, more preferably less than 0.5% and most preferably less than 0.1%.

One preferred embodiment of the present invention is one in which the wastewater from pharmaceutical manufacturing is treated by the present HMT process, where a contaminated wastewater stream is subjected to the treatment system, e.g., after treatment with a biological reactor or MBR.

Another preferred embodiment of the present invention is one in which the wastewater emerging from agrochemical production is subjected to the present treatment system, e.g., after treatment with a biological reactor or MBR.

Yet another preferred embodiment of the present invention is one in which the process and system of the present invention are used to treat wastewater from any fermentation process such as alcohol production, yeasts production, bio-fuel production or the like; such contaminated wastewater stream being subjected to the present treatment system, e.g., after treatment with a biological reactor or MBR. In such streams from food production the organic concentrate in soluble or precipitated form are concentrated to above 10% w/w, preferably to above 20% w/w and most preferably above 40% w/w. The organic stream contains reduced concentrations of minerals and thus is usable as food additives to animals.

Still another preferred embodiment of the present invention is one in which the process and system of the present invention are used to treat wastewater (from leachates) emerging from solid wastes dumping sites, such contaminated wastewater stream being subjected to the present treatment system, e.g., after treatment with a biological reactor or MBR. Of specific interest is a mineral stream from the ED step containing mainly ammonium salts, that can be released as ammonia, or scrubbed into nitric, phosphoric or sulfuric acid forming liquid fertilizers.

A further preferred embodiment of the present invention is one in which the process and system of the present invention are used to treat wastewater from food industrial processes such as those producing milk, cheese or meat; the wastewater stream being subjected to the present treatment system, e.g. after treatment with a biological reactor or MBR.

### EXAMPLES

The advantages of the present invention, will be illustrated in the following non-limiting examples.

Adsorption efficiency of activated carbon with and without NF is demonstrated in Examples I and II.

### Example I

Adsorption of methylene blue dye (MB) with activated carbon was determined by preparing a set of 1 liter solutions of methylene blue in distilled water, varying the concentration of methylene blue from 100 ppm to 1000 ppm. The solutions were stirred over night, then 50 ml samples were removed from each vessel, the remaining concentration of methylene blue was measured by means of spectrophotometer and the amount of adsorbed methylene blue per each gram of carbon was calculated. The results are given in Table 1 below. It is clear from this example that the efficiency of adsorption of organic molecules sharply decreases when the concentration of the organic solute in the solution decreases.

TABLE 1
Efficiency of adsorption of methylene blue (MB) by
active carbon vs. MB
concentration in the equilibrating solution

| | concentration of Methylene Blue in: | | | | | |
|---|---|---|---|---|---|---|
| | aqueous solution | | | activated carbon | | |
| No. | mMoles/l | ppm | % w/w | mMoles/gr | gr/gr | % w/w |
| 1 | 0.20 | 75 | 0.008% | 0.2 | 0.07 | 7% |
| 2 | 0.25 | 94 | 0.009% | 0.5 | 0.19 | 19% |
| 3 | 0.30 | 112 | 0.011% | 0.7 | 0.26 | 26% |
| 4 | 0.40 | 150 | 0.015% | 1.0 | 0.37 | 37% |
| 5 | 0.50 | 187 | 0.018% | 1.3 | 0.49 | 49% |
| 6 | 0.60 | 224 | 0.022% | 1.4 | 0.52 | 52% |

### Example II

The following experiment was done in a lab scale test cell, made of a stainless steel pressure vessel that is composed of two main parts: (a) a bottom flanged section having sintered SS support with the nanofiltration membrane mounted on top of the sinter, and (b) the upper part, which is a flanged SS cylinder, equipped with a magnetic stirrer and with an upper-flanged cover.

The cell was filled with a test solution containing 150 ml of 75 ppm methylene blue solution; the original amount of MB in the cell was 11.3 mg. To the MB test solution we added 11 milligrams of AC in powdered form. The flanges of the test cell were tightly assembled; the magnetic stirrer started and pressure was supplied from a compressed nitrogen balloon through a pressure regulator. The pressure rating was 40 bars.

Upon the application of pressure, the forced test liquid permeated across the membrane. The nanofiltration membrane that was installed in the cell was of a type Nano Pro-BPT-NF-4, having glucose rejections of 95% and 100% rejection to methylene blue. Rejection (%) is defined by equation (1), where C_{P} is dye concentration in the permeate solution and C_{C} is dye concentration on the concentrate side. 100% dye rejection indicates that the concentration of dye in the permeate stream is 0 ppms.

Re j(%)=(1−C_{P}/C_{C})*100 (1)

Because of this high MB rejection, the permeate did not contain any MB and all of it was concentrated in the cell.

The experiment continued until 135 ml of permeate were removed from the cell thus concentrating the MB 10 fold (Volume Concentration Factor−VCF=10).

The cell was opened, the concentrate solution was filtered to separate the carbon particles and the concentration of MB was measured and was found to be 400 ppm. Since the remaining concentrate volume was 15 ml, the calculated amount of MB in the aqueous solution was 4.5 milligrams and the amount adsorbed by 11 milligrams of activated carbon was 6.7 milligrams. Thus, the absorption capacity of MB by active carbon hybridized to the nanofiltration membrane was ˜60%. Based on the absorption experiment data given in Table 1, one would expect that the amount of MB absorbed by AC should be only 7%.

This experiment demonstrates the advantages of hybridization of AC with a pressure driven unit such as NF.

### Example III

### Effect of Activated Carbon on the Membrane Flux During Processing of Ultrafiltered Wastewater

The experiments were done in the lab cell described in Example II. The cell included the same type of membrane as in Example II. Several concentration runs were performed using wastewater from a pharmaceutical company, which was treated chemically by increasing the pH and adding trisodium phosphate in order to precipitate all calcium and magnesium ions. The turbidity was removed by means of an ultrafiltration membrane with a molecular weight cutoff of 200,000 Daltons. The crystal clear permeate of UF was used in all subsequent experiments. The concentration of organic matter in such treated stream was TOC=2380 ppm and the salt concentration was 2.5%.

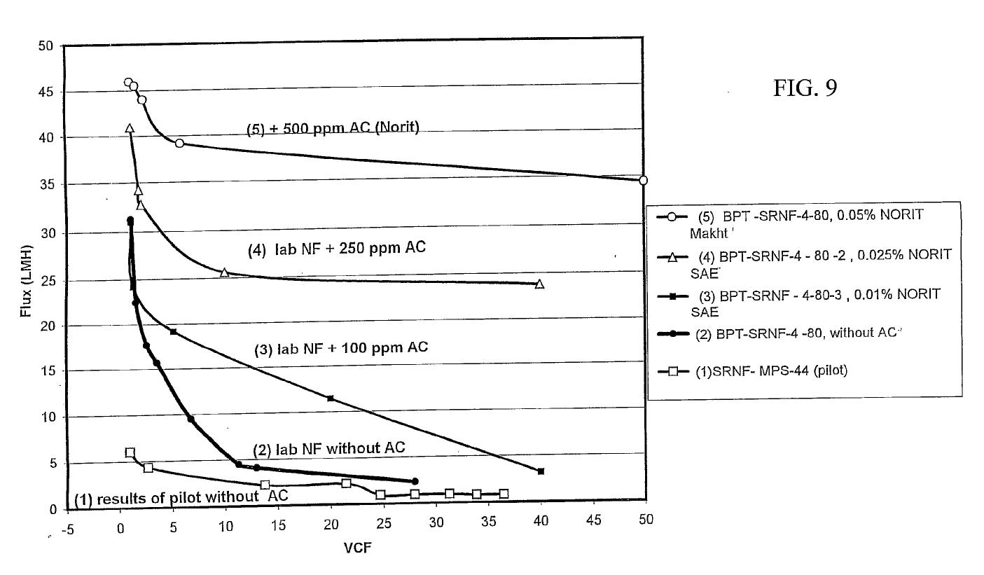

The membrane fluxes were measured during the concentration run up to Volume Concentration Factor (VCF) values of up to VCF values=50. The results showing the fluxes as a function of the concentration of activated carbon are given in FIG. 9. The results clearly show that without the presence of activated carbon the membrane flux dropped very sharply at VCF=10 to a flux of ˜5 liters/m2*hour, while the addition of 100 ppm only of activated carbon helped to maintain flux of above 10 Imh at VCF=20. Further increase of AC to 250 ppm only helped to keep flux at levels ˜25 Imh at VCF=40 and the addition of 500 ppm AC kept the fluxes at values higher than 35 at VCF=50.

For comparison there is shown in the same graph results obtained with a commercial NF membrane of Koch membranes MPS-44 in pilot experiments without the addition of active carbon.

### Example IV

The following experiment demonstrates the effectiveness of the hybrid membrane system according to the present invention in separating the wastewater stream into products which may be recycled. The system was constructed according to the details shown in the figures, and containing the following components:

A tubular ultrafiltration system with an 8 mm tube diameter and a cutoff of 200000 Daltons. The UF system was operated at a linear velocity of 4 meters per second at a pressure of 1 bar, using an industrial wastewater stream that was first chemically prepared according to Example Ill. Average flux achieved at these conditions at VCF of 10 was 300 liters/m2*hr*bar. The crystal clear permeate was fed into a feed tank of a nanofiltration system, that was equipped with a small activated carbon column containing 100 grams of activated carbon. The nanofiltration experiment used a solvent-stable and chemically stable spiral nanofiltration element Nano-Pro-BPT-NF-4 2.5″ in diameter and 14″ in length. The experiment was run for a period of 1 month processing a total wastewater volume of 1000 liters. The average consumption of activated carbon achieved was 100 ppm. An average high flux rate of 20 Imh was achieved in these experiments. The permeate of this experiment was constantly added to a hybrid RO/ED unit generating a concentrated brine of 20% containing only 140 ppm of organic contaminants and RO permeate with a salinity of less than 100 ppm and organic contents of less than 10 ppm.

During this experiment the recovery of the RO permeate was 90%.

This experimental set did not include a centrifuge or a membrane distillation unit.

Contacting the nanofiltration concentrate with a backflashable ultrafiltration device, in accordance with the present invention, gave improved results including prolongation of the life of the nanofiltration membrane.

### Example V

The following experiment demonstrates the effectiveness of the hybrid membrane system in recovering valuable minerals from a wastewater stream. The hybrid system used in this experiment was similar to the one presented in example IV with several changes.

a. The wastewater stream was not treated by means of biological treatment and contained dilute −3.5% of CaCl₂ contaminated with several hundred ppm of organic substances and aggressive organic solvents such as: 1.2 dichloropropane, acetone and di-chloro-di-isopropyle ether.
b. The stream was processed in the UF system at a high pH>11
c. Instead of using an RO membrane in the main treatment step, a NF membrane was used of the same type mentioned in Example IV. The pH during this experiment was reduced to around 3.

The results of processing this stream were as follows: CaCl₂ concentrate of 20% was achieved with only 120 ppm of TOC. This means that the concentrated recovered product was highly purified.

Contacting the nanofiltration concentrate with a backflashable ultrafiltration device, in accordance with the present invention, gave improved results including prolongation of the life of the nanofiltration membrane.

### Example VI

Salt concentrate from Example V was processed in a laboratory set up containing a membrane distillation unit equipped with hydrophobic polypropylene membranes that pass only water vapors but not liquid water. The driving force was created by vacuum on the permeate side and warming the solution on the saline side. During this experiment the concentration of the saline stream was increased from 20% to nearly 40%. The preconcentrated solution was cooled to 4° C., allowing CaCl2 salt to precipitate in the form of crystals that contained 70% w/w of pure CaCl2.

It is clear to a person in the field how such a unit can be integrated in a large scale commercial plant for concentrating the concentrate of ED to solid salt.

### Example VII

A sample of wastewater stream after treatment with a MBR (membrane biological reactor) was inserted into a NF test cell equipped with an NF membrane (type BPT-NF-3) characterized by glucose rejection of 90%. The test volume was 150 ml, the membrane area 13 cm² and the concentration experiment was performed at an operating pressure of 30 bars. The TOC of the feed sample was 1100 mg/l. The sample was concentrated 10 fold generating 15 ml of concentrate with a TOC value of 8200 mg/l and 135 ml of permeate with a TOC content of 300 mg/l. The results of this experiment suggest that the NF concentration proceeded as expected, where the soluble TOC fraction was concentrated in a test cell in accordance with the volumetric concentration factor (VCF=10) and membrane rejection.

### Example VIII

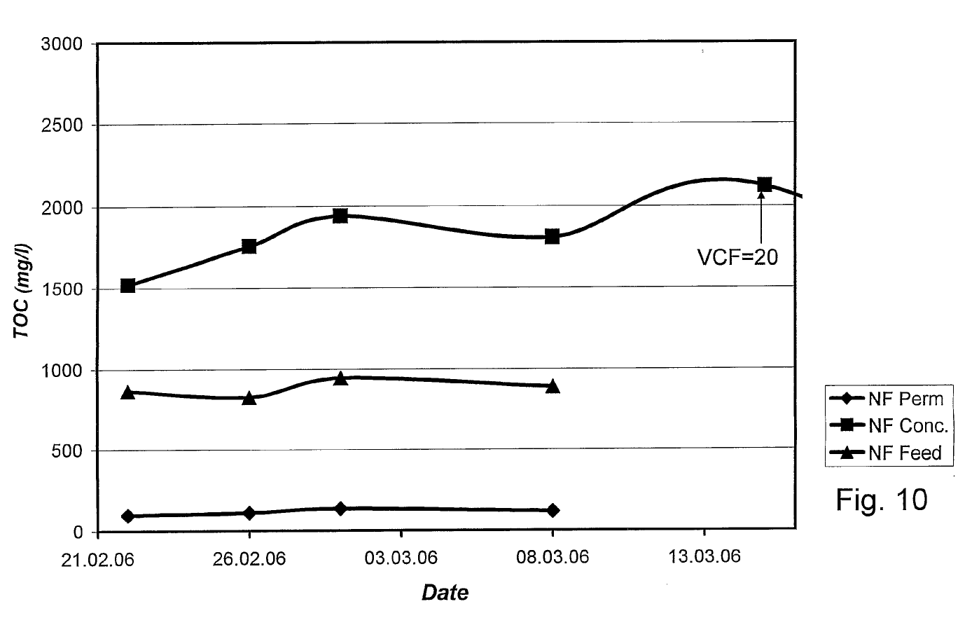

A wastewater stream after treatment with a MBR as in example VII was processed in a NF system comprising a NF reservoir of 30 liters, a carbon column, and a NF pump that increases the pressure of the NF feed to 20 bars and circulates it across a 2.5 inches spiral wound NF element characterized by a glucose rejection of 90%. The NF permeate is removed from the NF system at a flow rate of 1 liter/hour and the volume in the NF reservoir is constantly replenished with fresh feed from the MBR at a rate of 1 liter/hour; the average retention time of the liquid in the NF system is around 30 hours. The TOC concentration of the permeate and the concentrate streams was measured periodically as a function of time and the volumetric concentration achieved in the experiment. The results of these measurements are shown in FIG. 10. As observed, surprisingly, the concentration of the organic matter in the NF concentrate does not increase in proportion to the VCF but stays at a much lower than expected value. When the volumetric concentration factor reached a value of 20 and the concentration of the organic matter in the concentrate was expected to reach ˜20000 mg/l the actual TOC value measured was only 2100 mg/l, namely only 10% of the expected value.

The activated carbon was removed and analyzed for the presence of active biomass, which was found. These results indicate the formation of a new type of activated carbon—biological reactor hybridized within a nanofiltration step.

Contacting the nanofiltration concentrate with a backflashable ultrafiltration device, in accordance with the present invention, gave improved results including prolongation of the life of the nanofiltration membrane.

### Example IX

### A Comparative Example Demonstrating Improved Performance of NF Step Operating with UF that Removes Precipitates from NF Concentrate

Industrial wastewater from a pharmaceutical plant that was first treated in a biological waste water treatment plant and then, containing 700-1200 mg/liters of total organic carbon (TOC) and 2% minerals, was fed to an HMT (Hybrid Membrane Technology) pilot plant.

The pH of the stream was increased from an initial value of 8.2 to above 10 and filtered through a first UF stage equipped with 1″ tubular membrane containing 8 mm diameter UF membranes rated with 20-30 nanometer sized pores. The operating pressure was ˜1 bar and circulation velocity inside the UF module was ˜4 cubic meters/hour, creating a linear velocity inside the tubular UF membranes of 4 meters/second. The concentration of the Ca ions was reduced from an initial value of ˜400 mg/liters down to less than 10 mg/liters. The volume of suspended matter concentrate from this UF step was less than 0.5% of the total feed volume processed in this step.

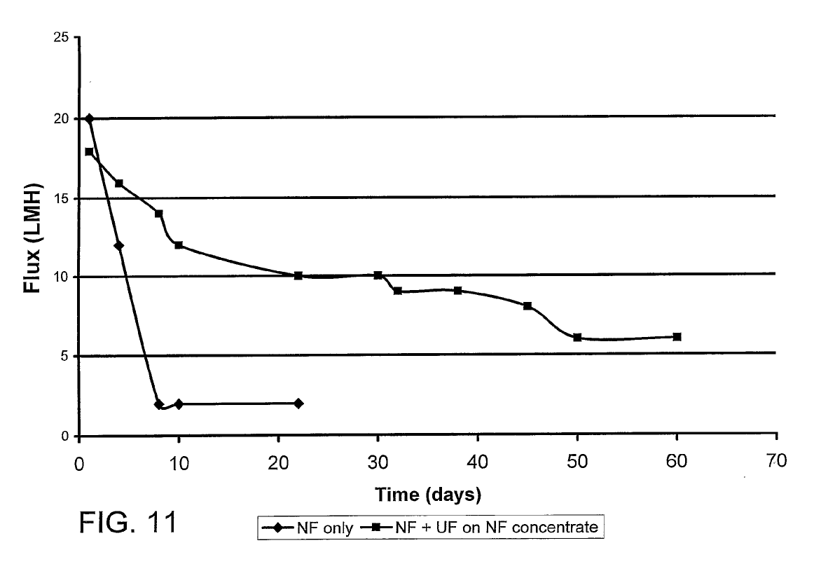

The permeate from the above UF step was continuously fed to a hybrid NF unit containing a 20 liter stainless steel NF reservoir equipped with a high pressure (30 bars) pump that was continuously circulating the above mentioned UF permeate across a solvent resistant spiral wound element (BPT-NFSR-4) a product of BPT—Bio Pure Technology Ltd. The molecular weight cut off (MWCO) rating of this element is ˜200 (characterized by ˜95% glucose rejection) and had physical dimensions of 2.5 inches diameter and 14 inches in length. The permeate from the NF step was continuously fed into a subsequent RO step, while the concentrate was recycled back to an NF feed reservoir passing on the way across a granulated carbon filter containing 100 grams of activated carbon. The organic matter retained by the membrane was volumetrically concentrated in the feed tank by a factor of 20 or more. The initial permeate flow rate was ˜15 liters/m²/hour (LMH). The permeate flow rate was recorded as a function of operating time and is given in FIG. 11. As observed the permeate flow rate was rapidly declining from a value of 15 LMH down to 2 LMH indicating membrane fouling after only 3 days. After a period of about 2 weeks the experiment stopped, all liquid from the feed tank was removed, the activated carbon was replaced with a fresh portion and a spiral NF element was cleaned by means of a cleaning in place (CIP) system.

In a further experiment, the NF system described above was modified by adding to the lower exit of the NF reservoir an additional low pressure pump that circulated a part of the NF concentrate across a tubular ceramic UF element rated with a MWCO of 20,000 Daltons. The clear permeate of the second UF unit was returned to the NF tank. The UF element was periodically back-flushed by means of UF permeate and the back flush stream containing suspended matter was allowed to settle in a separate reservoir. The supernatant liquid, lean in suspended matter, was returned to the NF feed tank for reprocessing. The flux of the NF element was recorded as a function of time and is given in same FIG. 11. It is evident that when a second UF system was operated in hybridized manner with the NF concentrate, the fluxes remained at much higher levels for a period exceeding 2 months.

While the present invention has been illustrated by description and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative system and methods, and illustrative examples shown and described. Accordingly, departures may be made from such details without departing from the spirit or scope of applicant's general inventive concept.

1-15. (canceled)

16. In a module having utility for reducing the content and volume of organic matter in a wastewater stream containing the same, and which includes at least one nanofiltration device, the improvement which comprises integrating said device with activated carbon in the same and/or separate vessel(s), with such connecting conduits as may be necessary to connect between the nanofiltration device and the activated carbon, if separate, such that nanofiltration initial and/or recirculated input circulates across the nanofiltration membrane and the activated carbon; whereby a fraction of the activated carbon conventionally required is effective to prevent fouling of the nanofiltration device.

17. A module according to claim 16, which comprises items (a), (b) and (c), and optionally (d):
(a) a nanofiltration device as defined in claim 16;
(b) a preferably backflashable ultrafiltration device tagged in the claims UF-1;
(c) conduit(s) adapted to convey nanofiltration device concentrate to UF-1;
(d) a vessel containing activated carbon and conduit(s) adapted to convey said nanofiltration device concentrate to said vessel for contact with said active carbon;
wherein the module comprises also: inflow conduit(s) adapted to convey said stream to said nanofiltration device; and outflow conduit(s) for said UF-1 concentrate and permeate and the nanofiltration device permeate.

18. A module according to claim 17, which is further characterized by at least one of the following features:
(i) said nanofiltration device has a cut-off of ≦1000 Daltons, preferably ≦500 Daltons and more preferably ≦160 Daltons;
(ii) said nanofiltration device is stable at pH 7-14;
(iii) said nanofiltration device is stable at pH 0-7;
(iv) said nanofiltration device is stable in presence of water-miscible and water-immiscible organic solvents;
(v) said wastewater stream is essentially free of salts of precipitable metal ions,
(vi) said module also comprises a vessel containing activated carbon adapted for contact with inflow wastewater prior to contact with said nanofiltration device, provided that such activated carbon and any other activated carbon as recited in claim 17, in whole or in part, may optionally support organic-matter-degrading bacteria, and as an additional or alternative option, a single vessel containing said activated carbon is operative to contact said inflow wastewater, and to contact said nanofiltration device concentrate.

19. System which comprises at least one module as defined in claim 16, for treating a wastewater stream containing salts of precipitable metal ions, salts of non-precipitable metal ions and organic matter including organic solvents and solutes, and which further optionally comprises the following units:
(A) a reactor, provided with wastewater stream inflow conduit(s), inflow conduit(s) for reactants adapted to form water insoluble salts by reaction with precipitable metal ions in said stream, outflow conduit(s) for removal as a slurry of said water-insoluble salts, and outflow conduit(s) for conducting said stream depleted in precipitable inorganic salts to unit (B);
(B) an ultrafiltration device tagged in the claims UF-2, adapted to reduce the content of salts of precipitable metal ions in said salts-depleted stream to less than 100 ppm, and provided with inflow conduit(s) for said salts-depleted stream, inorganic salt precipitate UF-2 concentrate outflow conduit(s) and essentially precipitable metal ion free UF-2 permeate outflow conduit(s).

20. System according to claim 19, which includes additionally one of the following features (D1) (D2) and (D3):
(D1) a combination of electrodialysis and reverse osmosis membranes adapted to operate in series or in parallel, simultaneously or sequentially, and to receive said nanofiltration device permeate having a reduced content of organic matter, in order to separate it into a concentrate containing essentially all of the salts of non-precipitable metal ions and a still more reduced content of organic matter, and a permeate of essentially pure water;
(D2) a membrane distillation unit operative to receive said nanofiltration device permeate, in order to separate it into a concentrate containing essentially all of the salts of non-precipitable metal ions and organic solutes and a permeate of essentially pure water;
(D3) a combination of electrodialysis and membrane distillation membranes adapted to operate in series or in parallel, simultaneously or sequentially, and to receive said nanofiltration device permeate in order to separate it into a membrane distillation condensate of essentially pure water and a mineral concentrate of said electrodialysis membrane(s) essentially free from organic contaminants; and optionally at least one of the following features (E) and (F):
(E) a unit adapted for the destruction of organic matter received from said outflow conduit(s) of UF-2 concentrate, and optionally also from said vessel containing activated carbon;
(F) at least one unit adapted to oxidize under ultraviolet radiation or by catalytic oxidation, any low molecular organic compounds at one or more of the following points:
(i) on said nanofiltration device permeate; and/or
(ii) on the reverse osmosis permeate and/or the electrodialysis concentrate (salt); and/or
(iii) on the membrane distillation permeate and/or on the membrane distillation concentrate.

21. System which comprises at least one module according to claim 18, for treating a wastewater stream containing salts of precipitable metal ions, salts of non-precipitable metal ions and organic matter including organic solvents and solutes, which comprises the following units:
(A) a reactor, provided with wastewater stream inflow conduit(s), inflow conduit(s) for reactants adapted to form water insoluble salts by reaction with precipitable metal ions in said stream, outflow conduit(s) for removal as a slurry of said water-insoluble salts, and outflow conduit(s) for conducting said stream depleted in precipitable inorganic salts to unit (B);
(B) device UF-2, adapted to reduce the content of salts of precipitable metal ions in said salts-depleted stream to less than 100 ppm, and provided with inflow conduit(s) for said salts-depleted stream, inorganic salt precipitate UF-2 concentrate outflow conduit(s) and essentially precipitable metal ion free UF-2 permeate outflow conduit(s).

22. System according to claim 21, which includes additionally one of the following features (D1) (D2) and (D3):
(D1) a combination of electrodialysis and reverse osmosis membranes adapted to operate in series or in parallel, simultaneously or sequentially, and to receive said nanofiltration device permeate having a reduced content of organic matter, in order to separate it into a concentrate containing essentially all of the salts of non-precipitable metal ions and a still more reduced content of organic matter, and a permeate of essentially pure water;
(D2) a membrane distillation unit operative to receive said nanofiltration device permeate, in order to separate it into a concentrate containing essentially all of the salts of non-precipitable metal ions and organic solutes and a permeate of essentially pure water;
(D3) a combination of electrodialysis and membrane distillation membranes adapted to operate in series or in parallel, simultaneously or sequentially, and to receive said nanofiltration device permeate in order to separate it into a membrane distillation condensate of essentially pure water and a mineral concentrate of said electrodialysis membrane(s) essentially free from organic contaminants; and optionally at least one of the following features (E) and (F):
(E) a unit adapted for the destruction of organic matter received from said outflow conduit(s) of said UF-2 concentrate, and optionally also from said vessel containing activated carbon;
(F) at least one unit adapted to oxidize under ultraviolet radiation or by catalytic oxidation, any low molecular organic compounds at one or more of the following points:
(i) on said nanofiltration device permeate; and/or
(ii) on the reverse osmosis permeate and/or the electrodialysis concentrate (salt); and/or
(iii) on the membrane distillation permeate and/or on the membrane distillation concentrate.

23. A process for reducing the content and volume of organic matter in a wastewater stream containing the same, or for treating a wastewater stream containing salts of precipitable metal ions, salts of non-precipitable metal ions and organic matter including organic solvents and solutes, or for reducing the content and volume of organic matter in a wastewater stream containing the same, and which stream is essentially free of salts of precipitable metal ions, which process comprises contacting said wastewater stream with at least one nanofiltration device in the form of a module as defined in claim 16.

24. A process according to claim 23 for reducing the content and volume of organic matter in a wastewater stream containing the same, which comprises contacting said wastewater stream with a nanofiltration device integral with activated carbon in the same or different vessel(s) so as to obtain a concentrate, and a permeate as an aqueous stream containing any salts of non-precipitable metal ions which may be present in said wastewater stream, then contacting said concentrate with a preferably backflashable device UF-1, and optionally also with the same or different activated carbon, in order to reduce the content and volume of organic matter in said concentrate.

25. A process according to claim 24, which is further characterized by at least one of the following features:
(i) said nanofiltration device has a cut-off of ≦1000 Daltons, preferably ≦500 Daltons and more preferably ≦160 Daltons;
(ii) said nanofiltration device is stable at pH 7-14;
(iii) said nanofiltration device is stable at pH 0-7;
(iv) said nanofiltration device is stable in presence of water-miscible and water-immiscible organic solvents;
(v) said wastewater stream is essentially free of salts of precipitable metal ions;
(vi) any recited activated carbon, in whole or in part, supports organic-matter-degrading bacteria, and as an additional or alternative option, a single body of said activated carbon is used to contact inflow wastewater, and to contact said nanofiltration device concentrate.

26. A process according to claim 23 for treating wastewater containing salts of precipitable metal ions, salts of non-precipitable metal ions and organic matter including organic solvents and solutes, which comprises the following sequential steps:
(A) contacting said wastewater with reactants adapted to precipitate water-insoluble salts of precipitable metal ions therefrom, removing the formed slurry of said water-insoluble salts, and conducting said wastewater depleted in inorganic salts to step (B);
(B) contacting said wastewater from step (A) with device UF-2, adapted to reduce the content of precipitable metal ions in said salts-depleted stream to less than 100 ppm; and
(C) contacting permeate from UF-2 with a nanofiltration device integral with activated carbon in the same or different vessel(s) so as to obtain a concentrate having a reduced content and volume of organic matter, and a permeate as an aqueous stream containing any salts of non-precipitable metal ions which may be present in said wastewater, then contacting said concentrate with preferably backflashable UF-1.

27. A process according to claim 26, which includes additionally one of the following steps (D1) (D2) and (D3):
(D1) contacting said nanofiltration device permeate with a combination of electrodialysis and reverse osmosis membranes adapted to operate in series or in parallel, simultaneously or sequentially, in order to separate said permeate having a reduced content of organic matter into a concentrate containing essentially all of the salts of non-precipitable metal ions and having a still more reduced content of organic matter, and a permeate of essentially pure water;
(D2) contacting said nanofiltration device permeate with a membrane distillation unit, in order to separate said permeate into a concentrate containing essentially all of the salts of non-precipitable metal ions and a permeate of essentially pure water;
(D3) contacting said nanofiltration device permeate with a combination of electrodialysis and membrane distillation membranes adapted to operate in series or in parallel, simultaneously or sequentially, and to receive said nanofiltration device permeate in order to separate it into a membrane distillation condensate of essentially pure water and a mineral concentrate of said electrodialysis membrane(s) essentially free from organic contaminants.

28. A process according to claim 27, which includes additionally at least one of the following steps:
(E) destroying the organic matter in the UF-2 concentrate;
(F) contacting with ultraviolet radiation or subjecting to catalytic oxidation, said nanofiltration device permeate, and/or the reverse osmosis permeate, and/or the electrodialysis concentrate (salt), and/or the molecular distillation permeate and/or the membrane distillation concentrate, in order to oxidize any low molecular organic compounds present therein.

29. In a process according to claim 23 for reducing the content and volume of organic matter in a wastewater stream containing the same, and which stream is essentially free of salts of precipitable metal ions, wherein said wastewater stream is contacted with a nanofiltration device integral with activated carbon in the same or different vessel(s) so as to obtain a concentrate having a reduced content and volume of organic matter, and a permeate as an aqueous stream containing any salts of non-precipitable metal ions which may be present in said wastewater stream;
the improvement which comprises a step of prolonging the life of said nanofiltration device by contacting said concentrate with device UF-1, thereby continuously removing precipitated matter formed in the nanofiltration device.

30. A process according to claim 29, which is further characterized by at least one of the following features:
(i) said nanofiltration device has a cut-off of ≦1000 Daltons, preferably ≦500 Daltons and more preferably ≦160 Daltons;
(ii) said nanofiltration device is stable at pH 7-14;
(iii) said nanofiltration device is stable at pH 0-7;
(iv) said nanofiltration device is stable in presence of water-miscible and water-immiscible organic solvents;
(v) said wastewater stream is essentially free of salts of precipitable metal ions;
(vi) said activated carbon, in whole or in part, may optionally support organic-matter-degrading bacteria;
(vii) device UF-1 is a backflashable device, and as an additional or alternative option, a single body of said activated carbon is used to contact inflow wastewater, and to contact nanofiltration device concentrate, in addition to said contacting of said nanofiltration concentrate with said UF-1.
